(19) United States
(12) Patent Application Publication
(10) Pub. No.: US 2012/0328942 A1
(43) Pub. Date: Dec. 27, 2012

(54) DESIGN AND FABRICATION OF ELECTRODES WITH GRADIENTS

(75) Inventors: Karen E. Thomas-Alyea, Arlington, MA (US); Richard K. Holman, Belmont, MA (US); Gilbert N. Riley, JR., Marlborough, MA (US); Susan J. Babinec, Midland, MI (US)

(73) Assignee: A123 Systems, Inc., Waltham, MA (US)

(21) Appl. No.: 13/582,778

(22) PCT Filed: Mar. 7, 2011
(86) PCT No.: PCT/US11/27416

§ 371 Date: Sep. 5, 2012

Related U.S. Application Data
(60) Provisional application No. 61/310,887, filed on Mar. 5, 2010.
(60) Provisional application No. 61/393,969, filed on Oct. 18, 2010.

(51) Int. Cl. H01M 4/64

(52) U.S. Cl. 429/211

(57) ABSTRACT

An electrode has a front face furthest from the current collector and a back face closest to the current collector and Is disposed on the current collector, and the electrode has a primary gradient of one of a chemical, physical and performance properties of the electroactive particle composition between the front and back faces, with the proviso that the primary gradient is not a bulk porosity gradient. In some embodiments, the electrode further comprises one or more secondary gradients Imposed over the primary gradient. The secondary gradient is one or more gradients selected from the group consisting of particle size gradient, particle size distribution gradient, particle morphology gradient, particle internal porosity, bulk porosity, particle volumetric charge-transfer resistance gradient, particle specific surface area gradient, particle crystalline structure gradient, particle crystallite size gradient, particle chemical composition gradient, particle robustness to cycling gradient, binder gradient, conductive additive gradient, and combinations thereof.

### RELATED APPLICATIONS

This application claims the benefit of priority to co-pending U.S. Application No. 61/310,887, filed Mar. 5, 2010, which is incorporated in its entirety by reference. This application claims the benefit of priority to co-pending U.S. Application No. 61/393,969, filed Oct. 18, 2010, which is incorporated in its entirety by reference.

### INCORPORATION BY REFERENCE

All patents, patent applications and publications cited herein are hereby incorporated by reference in their entirety in order to more fully describe the state of the art as known to those skilled therein as of the date of the invention described herein.

### FIELD

This invention relates generally to electrochemical cells. More specifically, the invention relates to electrodes with non-uniform compositions and properties.

### BACKGROUND

Contemporary portable electronic appliances rely almost exclusively on rechargeable Li ion batteries as the source of power. This has spurred a continuing effort to increase their energy storage capability, power capabilities, cycle life and safety characteristics, and decrease their cost. Lithium ion battery or lithium ion cell refers to a battery having a negative electrode capable of storing a substantial amount of lithium at a lithium chemical potential above that of lithium metal.

Porosity of the electrode is an important factor of the cell which affects cell cycling characteristics. Appropriate porosity of the electrode material will allow good permeability of the electrolyte and rapid transport of lithium ions within the electrode. Choice of active materials, composition, shape, size and size distribution are additional parameters effecting cost, power, cycle life and safety characteristics.

### SUMMARY

An electrode having a primary gradient with respect to the thickness of the electrode is described. Gradient, as used herein, refers to a change of the composition of the electrode material from the front side of the electrode to the back side of the electrode. A variety of chemical, physical and performance properties of the composition of the electrode can be used to form the gradient, including the type and relative amount of electroactive material, binder, electrically conductive material, or other additives, as well as the shape, specific surface area, size and particle size distribution of any or all of the components of the composition. Non-limiting examples of physical properties associated with compositions of the electrode material include particle size, particle specific surface area, particle internal porosity, particle morphology, particle crystalline structure, particle crystallite size, and bulk porosity. The primary gradient does not include a bulk porosity gradient. Performance properties of the electrode material includes, but are not limited to, electrode active material's power density, particle volumetric charge-transfer resistance, and robustness to cycle.

Examples of gradient of the electrode include, but are not limited to, a particle internal porosity gradient, a particle size gradient, a particle size distribution gradient, a particle morphology gradient, a particle specific surface area gradient, a particle volumetric charge transfer resistance gradient, a gradient based on the particle's robustness to cycling, a binder gradient, a conductive additive gradient, and a combination thereof.

Methods of fabricating electrodes with a gradient are also described.

In one aspect, an electrode assembly is described, including:

a current collector; and

an electrode having a front face furthest from the current collector and a back face closest to the current collector disposed on the current collector, where the electrode has a primary gradient of one of a chemical, physical and performance properties of the electroactive particle composition between the front and back faces, with the proviso that the primary gradient is not a bulk porosity gradient.

In any of the preceding embodiments, the primary gradient is selected from the group consisting of particle size gradient, particle size distribution gradient, particle morphology gradient, particle internal porosity gradient, particle volumetric charge-transfer resistance gradient, particle specific surface area gradient, particle crystalline structure gradient, particle crystallite size gradient, particle chemical composition gradient, and particle robustness to cycling gradient.

In any of the preceding embodiments, the primary gradient includes a continuous change of electrode composition.

In any of the preceding embodiments, the primary gradient includes a stepwise change of electrode composition.

In any of the preceding embodiments, the electrode includes a plurality of layers with different electrode compositions.

In another aspect, an electrode with a compositional gradient on a current collector is described, including:
a first type electroactive particles at a front side of the electrode further from a current collector; and
a second type electroactive particles at a back side of the electrode closer to the current collector;
   where
the compositions of the first type particles and the second type particles form a particle compositional gradient changing from the font side of the electrode to the back side of the electrode; and
the compositional gradient includes at least one gradient of particle size, particle porosity, particle morphology, particle power characteristics, particle specific surface area, particle crystalline structure, particle crystallite size, amount of conductive additive in a particle layer, or amount of binder in a particle layer.

In any of the preceding embodiments, the electrode further includes one or more secondary gradients.

In any of the preceding embodiments, the secondary gradient is one or more gradients selected from the group consisting of particle size gradient, particle size distribution gradient, particle morphology gradient, particle internal porosity, bulk porosity, particle volumetric charge-transfer resistance gradient, particle specific surface area gradient, particle crystalline structure gradient, particle crystallite size gradient, particle chemical composition gradient, particle robustness to cycling gradient, binder gradient, conductive additive gradient, and combinations thereof.

In any of the preceding embodiments, the electrode includes a particle volumetric charge transfer resistance gradient wherein the volumetric charge-transfer resistance of the electrode particles increases from the front face to the back face of the electrode.

In any of the preceding embodiments, the electrode includes synthetic carbon, hard carbon, or a combination thereof at a first location, and natural graphite, high-capacity synthetic carbon, or a combination thereof at a second location, wherein the second location is closer to the current collector than the first location.

In any of the preceding embodiments, the carbon at the first location is one or more carbons selected from the group consisting of synthetic graphite, mesocarbon, and combinations thereof.

In any of the preceding embodiments, the electrode includes a carbon material with a d(002) lattice spacing of more than 3.36 Å at a first location and a carbon material with a d(002) lattice spacing of less than 3.36 Å at a second location, wherein the second location is closer to the current collector than the first location.

In any of the preceding embodiments, the electrode includes a particle size gradient.

In any of the preceding embodiments, the particle size increases from the front to the back face of the electrode.

In any of the preceding embodiments, the electrode includes a particle morphology gradient.

In any of the preceding embodiments, the electrode includes a particle specific surface area gradient.

In any of the preceding embodiments, the particle specific surface area decreases from the front to the back face of the electrode.

In any of the preceding embodiments, the electrode includes a particle internal porosity gradient.

In any of the preceding embodiments, the particle internal porosity decreases from the front to the back face of the electrode.

In any of the preceding embodiments, the electrode includes a particle size gradient and a porosity gradient.

In any of the preceding embodiments, the particle size of the electrode increases and the porosity of the electrode decreases from the front face to the back face of the electrode.

In any of the preceding embodiments, the electrode includes a particle volumetric charge-transfer resistance gradient and a porosity gradient.

In any of the preceding embodiments, electrode porosity decreases and the particle volumetric charge-transfer resistance increases from the front face to the back face of the electrode.

In any of the preceding embodiments, the electrode includes a particle specific surface area gradient and a porosity gradient.

In any of the preceding embodiments, the particle specific surface area decreases and the porosity of the electrode decreases from the front face to the back face of the electrode.

In any of the preceding embodiments, the electrode includes a particle volumetric charge-transfer resistance gradient and a particle specific surface area gradient.

In any of the preceding embodiments, the particle specific surface area decreases and the particle volumetric charge-transfer resistance increases from the front face to the back face of the electrode.

In any of the preceding embodiments, the electrode includes a particle volumetric charge-transfer resistance gradient, a particle specific surface area gradient, and a porosity gradient.

In any of the preceding embodiments, the particle volumetric charge-transfer resistance increases, the particle specific surface area decreases, and the porosity decreases from the front face to the back face of the electrode.

In any of the preceding embodiments, the electrode includes a particle size gradient, a particle specific surface area gradient, and a porosity gradient.

In any of the preceding embodiments, the particle size increases, the particle specific surface area decreases, and the porosity decreases from the front face to the back face of the electrode.

In any of the preceding embodiments, the electrode further includes a binder gradient.

In any of the preceding embodiments, the electrode further includes a conductive additive gradient.

In any of the preceding embodiments, the electrode further includes a binder gradient and a conductive additive gradient.

In any of the preceding embodiments, the electroactive particles includes a negative electrode active material.

In any of the preceding embodiments, the electroactive particles includes a positive electrode active material.

A lithium ion battery is described, including an electrode of any of the preceding embodiments.

In yet another aspect, a method of fabricating an electrode is described, having one or more gradients, including:

sequentially applying more than one layers of electroactive particle compositions onto a current collector to form a gradient of a property of the electroactive particle composition, said property selected from the group consisting of particle size, particle size distribution, particle morphology, particle internal porosity, particle volumetric charge transfer resistance, bulk porosity, particle specific surface area, particle crystalline structure, particle crystallite size, and any combination thereof and the compositions of the layers represent a gradient from the layer closer to the current collector to the layer further away from the current collector; and

calendering the applied layers of electroactive compositions.

In any of the preceding embodiments, the layer closer to the current collector includes electroactive particles with compressibility higher than the applied layer of electroactive composition further from the current collector.

In any of the preceding embodiments, the method includes calendering the applied layers after all layers are applied.

In any of the preceding embodiments, the method includes calendering the applied layer after each layer is applied.

In any of the preceding embodiments, a same or different calendering force during calendering is used after each layer is applied.

In any of the preceding embodiments, the electrode is a negative electrode.

In any of the preceding embodiments, the electrode is a positive electrode.

In yet another aspect, a method of fabricating an electrode with porosity gradient is described, including:

applying a layer of electroactive composition onto a current collector;

inducing the surface of the layer of electroactive composition to flocculate; and

calendering the applied layer of electroactive composition.

In yet another aspect, an electrode with graded porosity on a current collector is described, including:
a first type electroactive particles at a front side of the electrode further from a current collector; and
a second type electroactive particles at a back side of the electrode closer to the current collector;
   wherein
the first type electroactive particles have smaller particle sizes than the second type electroactive particles; and
the electrode has a graded porosity which is higher at positions at the front side of the electrode and lower at positions at the back side of the electrode.

In any of the preceding embodiments, the graded porosity includes a continuous porosity gradient including a continuous change of particle porosity from the front side to the back side.

In any of the preceding embodiments, the graded porosity includes a stepwise porosity gradient including a stepwise change of particle porosity from the front side to the back side.

In any of the preceding embodiments, the electrode includes a plurality of layers of electroactive particles with different porosities, where the layer further away from the current collector has porosity higher than the layer closer to the current collector.

The electrodes described herein are useful in applications for electric vehicles and hybrid vehicles, in which both high energy density and robustness towards high power pulse cycling are desired.

As used herein, the “front”, “front face”, or “front side” of the electrode refers to the region of the electrode which is positioned closer to the separator. As used herein, the “back”, “back face”, or “back side” of the electrode refers to the region of the electrode which is in electronic communication with and positioned closer to the current collector.

Also, as used herein, “particle size” refers to the aggregate particle size. The particles may have a distribution of particle sizes. Aggregate particle refers to collections of fused primary particles. Aggregate particle size refers to the average maximum dimension of the aggregate particles and not the primary particles making up the aggregate particle. Aggregates are further distinguished from agglomerates, which are loose associations of aggregates that can be readily dispersed.

Also, as used herein, “particle size distribution” refers to the fact that the particles may not have all the same size, but rather be distributed over a range of sizes. A distribution describes the average, minimum, and maximum particle sizes, as well as how the particle sizes are distributed between the minimum and maximum sizes. Distributions can be normal or skewed, unimodal or bimodal or multi-modal.

Also, as used herein, “particle internal porosity” refers to the porosity within a particle.

Also, as used herein, “bulk porosity” refers to the porosity between particles. Unless otherwise, specified, “porosity” generally refers to “bulk porosity”.

By “nanoscale,” it is meant that the particle size is less than 500 nm, and preferably less than 100 nm.

As used herein, rate capability refers to the ability to deliver energy at a high current. A cell with poor rate capability suffers from voltage dropping during a high-rate discharge, so that the cell hits the lower voltage limit sooner and therefore delivers less energy.

As used herein, charge transfer resistance refers to the resistance to reacting a lithium ion in electrolyte with an electron at the surface of the active material. Charge transfer resistance includes multiple components commonly referred to as exchange-current density and solid-electrolyte interphase resistance. Volumetric charge transfer resistance is the resistance normalized by the volume of active material

The average specific surface area of the particles of the electrode can be defined as the result of dividing the sum of the surface areas of all the particles in the electrode by the total mass of all the particles in the electrode.

Unless otherwise specifically defined, the term “particle”, as used herein, generally refers to the particles of the electrode active material.

### BRIEF DESCRIPTION OF THE DRAWING

The subject matter is described with reference to the following figures, which are presented for the purpose of illustration only and are not intended to be limiting.

FIG. 1 is an illustration of an electrode with a porosity gradient and a particle size gradient.

FIG. 2 is a comparison of computer-simulated voltage profile at 2 C discharge of cells including uniform specific surface area negative electrode and specific surface area-graded negative electrode.

FIG. 3 is a comparison of computer-simulated voltage profile at 2 C discharge of cells including a blend of particle with two sizes in a negative electrode and a particle size-graded negative electrode.

FIG. 4 is a comparison of three computer-simulated voltage profiles at 5 C discharge: a positive electrode with a uniform composition, a positive electrode with a porosity gradient, and a positive electrode with a porosity gradient and a specific surface area (volumetric charge-transfer resistance) gradient.

### DETAILED DESCRIPTION

Choice of active materials, composition, shape, size and size distribution are additional parameters effecting cost, power, cycle life and safety characteristics. Often there is a trade-off between these parameters; this trade-off can be managed with electrodes of graded composition.

Electrodes with gradients of one or more chemical, physical and performance properties across the thickness of the electrode are described. A variety of chemical, physical and performance properties of the composition of the electrode can be used to form the gradient, including the type and relative amount of electroactive material, binder, electrically conductive material, or other additives, as well as the shape, specific surface area, size and particle size distribution of any or all of the components of the composition. Non-limiting examples of physical properties associated with compositions of the electrode material include particle size, particle specific surface area, particle morphology, particle crystalline structure, particle crystallite size, particle internal porosity, and bulk porosity. Performance properties of the electrode material includes, but are not limited to, electrode active material's power density, particle volumetric charge-transfer resistance and robustness to cycling.

Examples of gradient of the electrode includes, but are not limited to, a bulk porosity gradient, a particle size gradient, a particle size distribution gradient, a particle morphology gradient, a particle specific surface area gradient, a particle internal porosity gradient, a particle volumetric charge transfer resistance gradient, a gradient based on the particle's robustness to cycling, a binder gradient, a conductive additive gradient, and combinations thereof.

In some embodiments, the electrode has a front face furthest from the current collector and a back face closest to the current collector disposed on the current collector, and the electrode has a primary gradient of one of a chemical, physical and performance properties of the electroactive particle composition between the front and back faces, with the proviso that the primary gradient is not a bulk porosity gradient.

The primary gradient is selected from the group consisting of particle size gradient, particle size distribution gradient, particle morphology gradient, particle internal porosity, particle volumetric charge-transfer resistance gradient, particle specific surface area gradient, particle crystalline structure gradient, particle crystallite size gradient, particle chemical composition gradient, and particle robustness to cycling gradient.

The gradient as described herein can be a continuous gradient or a stepwise gradient.

In some embodiments, the gradient of the electrode includes a continuous gradient including continuous change of particle properties from the front of the electrode to the back of the electrode. In these embodiments, the particle size, particle compositions, particle specific surface areas, or other particle properties changes continuously throughout the thickness of the electrode.

In other embodiments, the gradient of the electrode includes a stepwise gradient including a stepwise change from the front of the electrode to the back of the electrode. In these specific embodiments, the electrode includes a plurality of layers of active materials where each layer of active material includes particles with different property; e.g., different particle size, particle specific surface areas, or particle composition, and taken as a whole, the property of the particles gradually changes from the front of the electrode to the back of the electrode in a stepwise fashion.

In some embodiments, the gradient is a particle composition gradient. In some embodiments, the particle composition gradient is a particle size gradient, a particle size distribution gradient, a particle specific surface area gradient, a particle morphology gradient, a particle volumetric charge transfer resistance gradient, or a gradient based on the particle's robustness to cycling. In some embodiments, the morphology gradient includes a particle specific surface area gradient.

In some embodiments, the gradient in the electrode includes a gradient of particle size, particle size distribution, particle morphology, or particle composition. In some embodiments, the electrode gradient includes a particle specific surface area gradient. Generally, the term “particles”, as used herein, refers to the electrode active particle.

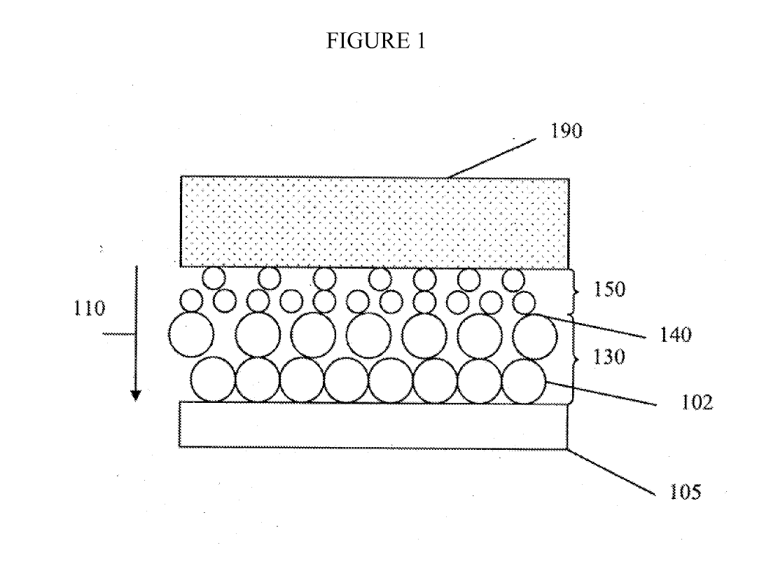

In some embodiments, the electrode includes a particle size gradient. The smaller particles are used in the front of the electrode. The small particles have an average particle size from about 0.1 micron to about 10 micron. The larger particles are used in the back of the electrode. The large particles have an average particle size from about 5 microns to about 50 microns. Referring to FIG. 1, the electrode layer 100 disposed upon current collect 105 includes a particle size gradient. Larger particles 120 are located in region 130 of the electrode closest to the current collector. Smaller particles 140 are located in region 150 of the electrode furthest from the current collector and closest to the separator. The variation in particle size provides increased mechanical robustness at the separator/electrode interface and adjacent electrode regions. The particles of different sizes can be layered as shown in FIG. 1 or they can exhibit a continuously changing particle size as the average particle size shifts from smaller to larger through the thickness of the electrode.

Electroactive materials with smaller particle sizes have better cell cycle life. Without being bound by any particular theory, it is believed that the smaller particles have smaller concentration gradients and thus have lower stress during cycling. In addition, during pulse cycling of a battery with electrodes with higher electronic conductivity than the electrolyte's ionic conductivity, more reaction occurs at the separator-side of the electrode (“front”) than at the current-collector side (“back”). Therefore, it is advantageous for cell cycle life to have particles which are robust against high currents at the front of the electrode. Conversely, if the electronic conductivity is lower than the ionic conductivity, then the reaction rate will start out highest at the back of the electrode. Therefore, to take advantage of having more robust structures at the front of the electrode, the back of the electrode needs to have electronic conductivity sufficiently higher than the ionic conductivity of the electrolyte.

In some embodiments, the gradient in the electrode includes a particle size distribution gradient. In some specific embodiments, particle powder with a narrow particle size distribution is often less compressible than a powder with a broad particle size distribution. A powder with a higher volume fraction of very small particles (<1 μm) is less compressible than a powder from which these “fines” have been removed. In some embodiments, particles with a narrow particle size are used at the front of the electrode and the particles with a broader particle size are used at the back of the electrode. In some embodiments, particles with higher volume fraction of very small particles (<1 μm) are used at the front of the electrode and the particles without such fine particles are used at the back of the electrode.

In some embodiments, the gradient in the electrode includes a gradient of particle morphology, e.g., the shape, size, texture, and phase of the electroactive particles. The gradient of particle morphology can include gradients in shape which affect compressibility. For example, spherical particles are usually more compressible than aspected particles, e.g., flakes. In some embodiments, flakes or other aspected particles are used at the front of the electrode and spherical particles are used at the back of the electrode. In some other embodiments, the gradients in particle morphology can include gradients in shape which affect ion transport around the particles. For example, particles oriented such that their edge planes face the separator would be placed closer to the front of the electrode, whereas particles oriented such that their basal planes face the separator would be placed closer to the back of the electrode. In some embodiments, the gradients in particle morphology can include gradients in shape which affect robustness. For example, aggregate particles with internal porosity will have higher robustness. In some embodiments, such more robust particles are used at the front of the electrode and less robust particles are used at the back of the electrode.

In some embodiments, the gradient in the electrode includes a gradient of particle internal porosity. Particles with high internal porosity can have higher robustness against cycling. Such particles can also have lower impedance because the internal porosity reduces the effective diffusion path length and, if the internal porosity is connected to the bulk porosity, then the internal porosity increases electrochemically active surface area, thereby lowering the charge-transfer resistance. The trade-off is that the existence of the internal porosity reduces the amount of the active material, so the material has lower energy density compared to a particle without internal porosity. In some embodiments, the electrode contains a gradient where the particle internal porosity decreases from the front to the back of the electrode.

In some embodiments, the electrode gradient includes a particle specific surface area gradient. In some specific embodiments, the front of the electrode includes particles with higher specific surface area and the back of the electrode includes particles with lower specific surface area. The electrode has a particle specific surface area gradient such that the particle specific surface area decreases across the thickness of the electrode, e.g., from the front of the electrode to the back of the electrode.

The particle specific surface area can be measured using the nitrogen adsorption Brunauer-Emmett-Teller (BET) method. In some embodiments, the average particle specific surface area of the electroactive materials is from about 0.2 m²/g to about 50 m²/g.

In some embodiments, the difference between the particle specific surface areas at the front of the electrode and the back of the electrode is more than about 0.2 m²/g, about 1 m²/g, about 2 m²/g, about 3 m²/g, about 5 m²/g, more than about 10 m²/g, more than about 15 m²/g, more than about 20 m²/g, more than about 25 m²/g, more than about 30 m²/g, more than about 35 m²/g, more than about 40 m²/g, more than about 45 m²/g, or more than about 50 m²/g.

In some embodiments, the electrode is a positive electrode and the average specific surface area of the positive electrode particles is greater than about 10 m²/g, greater than about 20 m²/g, greater than about 30 m²/g, greater than about 40 m²/g, or greater than about 50 m²/g. In some embodiments, the specific surface area of the particles at the front of the positive electrode is between about 20 m²/g to about 50 m²/g. In some embodiments, the specific surface area of the particles at the back of the positive electrode is between about 10 m²/g to about 40 m²/g. In some embodiments, the positive electrode has an electroactive particle specific surface area gradient such that the particle specific surface area decreases from about 50 m²/g at the front of the electrode to about 40 m²/g at the back of the electrode, about 30 m²/g at the back of the electrode, about 20 m²/g at the back of the electrode, or about 10 m²/g at the back of the electrode. In some embodiments, the positive electrode has an electroactive particle specific surface area gradient such that the particle specific surface area decreases from about 40 m²/g at the front of the electrode to about 30 m²/g at the back of the electrode, about 20 m²/g at the back of the electrode, or about 10 m²/g at the back of the electrode. In some embodiments, the positive electrode has an electroactive particle specific surface area gradient such that the particle specific surface area decreases from about 30 m²/g at the front of the electrode to about 20 m²/g at the back of the electrode, or about 10 m²/g at the back of the electrode. In some embodiments, the positive electrode has an electroactive particle specific surface area gradient such that the particle specific surface area decreases from about 20 m²/g at the front of the electrode to about 10 m²/g at the back of the electrode.

In some embodiments, the electrode is a negative electrode and the average specific surface area of the negative electrode particles is greater than about 0.2 m²/g, greater than about 1 m²/g, greater than about 2 m²/g, greater than about 3 m²/g, greater than about 4 m²/g, greater than about 5 m²/g, or greater than about 6 m²/g. In some embodiments, the specific surface area of the particles at the front of the negative electrode is between about 2 m²/g to about 6 m²/g. In some embodiments, the specific surface area of the particles at the back of the negative electrode is between about 0.2 m²/g to about 4 m²/g. In some embodiments, the negative electrode has an electroactive particle specific surface area gradient such that the particle specific surface area decreases from about 6 m²/g at the front of the electrode to about 5 m²/g at the back of the electrode, about 4 m²/g at the back of the electrode, about 3 m²/g at the back of the electrode, about 2 m²/g at the back of the electrode, about 1 m²/g at the back of the electrode, or about 0.2 m²/g at the back of the electrode. In some embodiments, the negative electrode has an electroactive particle specific surface area gradient such that the particle specific surface area decreases from about 5 m²/g at the front of the electrode to about 4 m²/g at the back of the electrode, about 3 m²/g at the back of the electrode, about 2 m²/g at the back of the electrode, about 1 m²/g at the back of the electrode, or about 0.2 m²/g at the back of the electrode. In some embodiments, the negative electrode has an electroactive particle specific surface area gradient such that the particle specific surface area decreases from about 4 m²/g at the front of the electrode to about 3 m²/g at the back of the electrode, about 2 m²/g at the back of the electrode, about 1 m²/g at the back of the electrode, or about 0.2 m²/g at the back of the electrode. In some embodiments, the negative electrode has an electroactive particle specific surface area gradient such that the particle specific surface area decreases from about 3 m²/g at the front of the electrode to about 2 m²/g at the back of the electrode, about 1 m²/g at the back of the electrode, or about 0.2 m²/g at the back of the electrode. In some embodiments, the negative electrode has an electroactive particle specific surface area gradient such that the particle specific surface area decreases from about 2 m²/g at the front of the electrode to about 1 m²/g at the back of the electrode, or about 0.2 m²/g at the back of the electrode.

In some embodiments, the particles of an electrode have an average specific surface area. The average specific surface area of the particles of the electrode can be defined as the total surface areas of all the particles in the electrode divided by the total mass of particles in the electrode. In some embodiments, the specific surface area of the particles at the front of the electrode is about 80% higher, about 70% higher, about 60% higher, about 55% higher, about 50% higher, about 45% higher, about 40% higher, about 30% higher, about 20% higher, or about 10% higher than the average specific surface area of the particles in the electrode. In some embodiments, the specific surface area of the particles at the back of the electrode is about 80% lower, about 70% lower, about 60% lower, about 55% lower, about 50% lower, about 45% lower, about 40% lower, about 30% lower, about 20% lower, or about 10% lower than the average specific surface area of the particles in the electrode.

The charge transfer resistance of the electroactive particles is inversely proportional to their specific surface area. Thus, electroactive materials with higher specific surface area can have lower volumetric charge transfer resistance due to their higher specific surface area, better charge-transfer resistance per unit specific surface area, or a combination of the two. In comparison, electroactive materials with lower specific surface area can result in higher specific charge transfer resistance. Therefore, it is desirable to increase the total surface area of the active material in the electrode to provide low-resistance and high-rate electrode. However, an increase of the particle specific surface area may result in an increase of side reactions. In a lithium ion battery, side reactions occur at the surface of negative electrodes at potentials below about 1 V vs. Li/Li⁺. These side reactions may result in loss of capacity and create metastable compounds that react exothermically at high temperature, thereby reducing the safety of the battery. Therefore, it is also desirable to limit the average specific surface area of the electroactive material in the negative electrode to reduce side reactions and improve the safety of the electrode.

In some specific embodiments, the front of the electrode includes particles with higher specific surface area which results in lower volumetric charge-transfer resistance (more power capacity). In these embodiments, the back of the electrode includes particles with smaller specific surface area which results in higher volumetric charge-transfer resistance (less power capacity). In these embodiments, the gradients of the electrode are such that the particle specific surface area decreases from the front of the electrode to the back of the electrode and the volumetric charge-transfer resistance decreases from the front of the electrode to the back of the electrode. The resulting electrode will have a minimized risk of side reaction and loss of capacity, a low resistance and high rate, and a desired volumetric charge transfer resistance profile.

Applicants have surprisingly found that an electrode with a specific surface area gradient can limit the average specific surface area of the electroactive particles in an electrode, e.g., a negative electrode, to maintain good safety and, at the same time, provide electrode with high rate capability and low resistance at the beginning of the discharge. In some embodiments, the front of the electrode includes particles with higher specific surface area and low resistance and the back of the electrode includes particles with lower specific surface and higher resistance. In these embodiments, the average specific surface area of the particles in the entire electrode remains low to provide an electrode of good safety. In a battery assembly, the specific surface area-graded electrode is combined with an electrolyte. Because of potential drop across the electrolyte in the electrode, the electrochemical reaction at the beginning of the discharge occurs at a higher rate at the front of the electrode. As the reaction proceeds, the electroactive particles at the front of the electrode will be consumed and the electrochemical reaction will shift to the back of the electrode. By placing particles with lower charge transfer resistance and higher specific surface area at the front of the electrode, the cell resistance at the beginning of the discharge is lower. As the electroactive particles with low charge transfer resistance are consumed, the reaction will shift to the electroactive particles at the back side of the electrode which has high charge transfer resistance and lower specific surface area. The impedance of the electrode at a later stage of discharge will be higher than that at the beginning of the discharge, due to the combined effects of longer electrolyte transport path and larger charge transfer resistance.

In some battery-operated devices and applications where the capacity of the battery is not typically utilized completely during a discharge event, it can be beneficial to minimize the cell resistance at beginning of the discharge. Non-limiting examples of such applications include electric and hybrid-electric vehicles and electricity-grid frequency regulation. The electrode with particle specific surface area gradient can also be used for high-rate applications in which the accessible capacity of the cell at high rate is lower than the accessible capacity at low rate because of transport limitations in the electrolyte. As a result, a cell with higher capacity at high rates can be obtained by using a gradient of particle specific surface area as disclosed herein.

In some embodiments, the electrode includes a particle volumetric charge transfer resistance gradient. In some specific embodiments, the volumetric charge-transfer resistance of the electrode particles increases from the front face to the back face of the electrode. In some specific embodiments, the electrode comprises an electroactive particle chemical composition gradient which results in the particle volumetric charge transfer resistance gradient. In these specific embodiments, the electrode includes synthetic carbon, hard carbon, or a combination thereof at a first location, and natural graphite, high-capacity synthetic carbon, or a combination thereof at a second location, where the second location is closer to the current collector than the first location. In these specific embodiments, the electrode includes synthetic carbon, hard carbon, or a combination thereof at the front of the electrode, and natural graphite, high-capacity synthetic carbon, or a combination thereof at the back of the electrode.

In some embodiments, the gradients in particle composition include a gradient based on the material's robustness to cycling. In some embodiments, electrode having materials more robust to cycling at the front of the electrode and materials with higher capacity are at the back of the electrode are described. Non-limiting examples of materials more robust to cycling include mesocarbon microbead (MCMB), less graphitic graphite, or hard carbon. Non-limiting examples of materials with lower robustness to cycling include highly graphitized graphite or natural graphite. In graphitic materials, it has been found that the crystal structure correlates to the cycle life. The particle robustness to cycling is related to the d(002) lattice spacing of the carbon material crystalline structure, where the particle robustness to cycling increases as the d(002) lattice spacing increases. In particular, materials with a larger d(002) lattice spacing have been found to have improved high-power cycle life. In some embodiments, the first location includes a carbon material with a d(002) lattice spacing of more than 3.36 Å and the second location comprises a carbon material with a d(002) lattice spacing of less than 3.36 Å. In some other embodiments, the gradient in particle composition can include having materials which are softer and more compressible at the back of the electrode and materials which are harder and less compressible at the front of the electrode. Non-limiting examples of more compressible materials include natural graphite. Non-limiting examples of less compressible materials include coke, coke-derived graphite, and hard carbon.

In some embodiments, the electrode includes a binder gradient. Non-limiting examples of binder gradient include a gradient in the mass ratio of binder to electroactive material. In some embodiments, the binder gradient can be combined with the particle composition gradient. For example, smaller particles and higher-surface-area particles often require more binder in order to maintain sufficient adhesion and cohesion within the electrode. Therefore, in some embodiments, the electrode has a binder gradient where the mass ratio of binder to electroactive material decreases from the front to the back of the electrode, a specific surface area gradient where the specific surface area decreases from the front to the back of the electrode, and/or a particle size gradient where the particle size increases from the front to the back of the electrode. The binder gradient can also be present with a uniform particle composition.

In some embodiments, the electrode includes a conductive additive. Non-limiting examples of conductive additive gradient include a gradient in the mass ratio of conductive additive to active material. The conductive-additive gradient can be combined with the particle composition gradient. For example, materials with lower intrinsic electronic conductivity or materials with a morphology that does not form good electronic connections with neighboring particles may show improved power density with a higher amount of conductive additive. Higher amounts of conductive additive may be needed closer to the current collector to ensure that the electrode electronic conductivity is higher than the electrolyte ionic conductivity, in order to focus the reaction-rate distribution at the front of the electrode at the beginning of discharge and charge. Therefore, in some embodiments, the electrode has a conductive additive gradient where the mass ratio of the conductive additive to electroactive material increases from the front to the back of the electrode, a specific surface area gradient where the specific surface area decreases from the front to the back of the electrode, and/or a particle size gradient where the particle size increases from the front to the back of the electrode. Smaller particles often require more conductive additive in order to keep contact between all the particles over the course of cycle life. Thus, in some embodiments, the electrode contains a particle gradient increasing and a conductive additive gradient increasing from the front to the back of the electrode. Such electrode has an improved cycle life. The conductive-additive gradient can also be present with a uniform particle composition. For example, the electronic current is higher closer to the current collector, and lower closer to the separator. Therefore, the overall power density may be improved by locating more of the conductive additive at the back of the electrode.

In some embodiments, the electrode includes a combination of two or more gradient described herein. In some embodiments, the electrode further includes one or more secondary gradients imposed over the primary gradient. The secondary gradient is one or more gradients selected from the group consisting of particle size gradient, particle size distribution gradient, particle morphology gradient, particle internal porosity, bulk porosity, particle volumetric charge-transfer resistance gradient, particle specific surface area gradient, particle crystalline structure gradient, particle crystallite size gradient, particle chemical composition gradient, particle robustness to cycling gradient, binder gradient, conductive additive gradient, and combinations thereof.

An electrode having improved rate capability and/or cycle life of batteries while optimizing volumetric energy density, gravimetric energy density and/or cost is provided by employing electrodes with non-uniform porosity and composition gradient. Electrodes with graded porosity have advantages in rate capability compared to electrodes with uniform porosity. Specifically, it is advantageous to have higher electrode porosity closer to the separator, and lower electrode porosity closer to the current collector. The electrodes include chemical, physical and performance property gradients across the thickness of the electrode selected to provide mechanical robustness during electrochemical cycling, while selecting a porosity gradient that improves uniformity of reaction-rate distribution.

In some embodiments, an electrode with a graded porosity is described, wherein the porosity is higher at the separator-side, or the front side, of the electrode and lower at the current-collector-side, or the back side, of the electrode. The electroactive materials can also have a range of different particle sizes, such that the electrode includes particles of a smaller particle size at the separator-side, or the front side, of the electrode and particles of a larger particle size at the current-collector-side, or the back side, of the electrode.

In some specific embodiments, a plurality of layers of electrode active material is included in an electrode, where each layer has a particle size different from any other layers. The layers of electroactive particles are arranged so that the layer closer to the front of the electrode will have electroactive particles with smaller particles sizes. A stepwise gradient of particles with other compositions or properties can be similarly obtained by strategic arrangement of the electroactive layers.

Batteries including graded porosity electrodes with higher porosity at the front of the electrode have improved cell characteristics. Without being bound by any particular theory, it is believed that higher porosity closer to the separator will facilitate the diffusion and migration of the ions. Ion transport occurs within the electrode through electrolyte which fills the pores of the porous electrode. The ions react across the depth of the electrode, and the flux of ions is highest at the positions of the electrode closest to the separator, and is the lowest or close to zero at the current collector. Therefore, an electrode with higher porosity at the front side of the electrode improves the ion transport, which in turn results in other beneficial cell properties such as improved rate capability and better cell cycle life.

Current literature in the battery field suggests that the cycle life of lithium ion batteries is affected by processes occurring in the electrode. For example, in a graphite electrode, intercalation/de-intercalation of lithium with the graphite can cause stress resulting in cracks on the graphite material surface, which in turn leads to loss of cyclable amount of lithium due to the reaction of lithium with the electrolyte (solid electrolyte interface formation, or “SEI” formation). The resulting stress to the graphite is higher if the local intercalation/de-intercalation reaction rate is higher. Generally in lithium ion batteries, the ionic conductivity of the electrolyte is lower than the electronic conductivity of the electrode solid phase. As a result, the reaction rate varies; at the beginning of charging or discharging the rate is highest at the electrode locations closest to the separator. At lower porosities in the electrode, the ionic conductivity through the electrolyte infusing the electrode is more restricted and the intercalation/de-intercalation reaction rate is less uniform throughout the thickness of the electrode. Therefore, the electrode with a lower porosity will more likely have regions with higher local reaction rate, thus contributing to higher stress. Furthermore, the SEI resulting from such increase stress can clog pores, causing the reaction rate to become even more non-uniform.

In some embodiments, the electrode is fabricated so that the front of the electrode containing small size particles has a higher porosity than the back of the electrode containing large size particles. Large size electroactive particles are more compressible than the small size electroactive particles so that an uniform calendering process generates lower porosity among the large size particles and higher porosity among the small size particles in a single step. The large size electroactive particles can be coated onto the electrode current collector first and subjected to calendering conditions to generate pre-determined lower porosity. Subsequently, the small size electroactive particles can then be coated and subjected to different calendering conditions to generate higher porosity than the back of the electrode containing large size particles.

Referring back to FIG. 1, the electrode layer 100 disposed upon current collect 105 includes a particle size gradient and a porosity gradient. As shown in FIG. 1, the electrode has a porosity gradient and incorporates smaller particles at the separator and larger particles at the current collector. The upper surface of the electrode layer is in contact with separator 190. The electrode layer has a porosity gradient from higher porosity at separator 190 to lower porosity at current collector 105. The gradient from higher to lower porosity is illustrated by arrow 110. In addition to an overall porosity gradient, the electrode also includes particles of different sizes. Larger particles 120 are located in region 130 of the electrode closest to the current collector. Smaller particles 140 are located in region 150 of the electrode furthest from the current collector and closest to the separator. The porosity gradient provides a more uniform intercalation/de-intercalation reaction rate, thus improving the ion transport; the variation in particle size provides increased mechanical robustness at the separator/electrode interface and adjacent electrode regions, thus providing lower resistance at the beginning of charge or discharge. The particles of different sizes can be layered as shown in FIG. 1 or they can exhibit a continuously changing particle size as the average particle size shifts from smaller to larger through the thickness of the electrode. Similarly, the electrode can include layers of uniform porosity where each layer has porosity different from an other layer or the electrode can comprise a continuum of changing porosity throughout its thickness.

In some embodiments, the electrode includes one or more electroactive material gradients, a binder gradient, and/or a conductive material gradient.

In some embodiments, the electrode includes a combination of a porosity gradient and a volumetric charge transfer resistance gradient. In some specific embodiments, the front of the electrode includes more porosity and electroactive material at the front of the electrode is robust to high-current cycling. In these embodiments, the back of the electrode includes less porosity and electroactive material at the back of the electrode is optimized for high energy capacity. In these embodiments, the gradients of the electrode are such that the porosity of the electrode decreases from the front of the electrode to the back of the electrode and the particle volumetric charge transfer resistance increases from the front of the electrode to the back of the electrode.

In some embodiments, the electrode includes a combination of a specific surface area gradient and a porosity capacity. In some specific embodiments, the front of the electrode includes particles with higher specific surface area and higher porosity. In these embodiments, the back of the electrode includes particles with smaller specific surface area, lower porosity, and higher volumetric charge-transfer resistance (lower power capacity). In these embodiments, the gradients of the electrode are such that the particle specific surface area decreases from the front of the electrode to the back of the electrode, the porosity of the electrode decreases from the front of the electrode to the back of the electrode, and the volumetric charge-transfer resistance increases from the front of the electrode to the back of the electrode. The resulting electrode will have a minimized risk of side reaction and loss of capacity, a low resistance and high rate, and a desired volumetric charge transfer resistance profile.

In some embodiments, the electrode includes a combination of a specific surface area gradient, a porosity capacity, and a particle size gradient. In some specific embodiments, the front of the electrode includes particles with higher specific surface area, higher porosity, and smaller particle size. In these embodiments, the back of the electrode includes particles with smaller specific surface area, lower porosity, and larger particle size. In these embodiments, the gradients of the electrode are such that the particle sizes increases from the front of the electrode to the back of the electrode, the porosity of the electrode decreases from the front of the electrode to the back of the electrode, and the particle specific surface area decreases from the front of the electrode to the back of the electrode. The resulting electrode will have a minimized risk of side reaction and loss of capacity, a low resistance and high rate capability, and a desired cyclability.

In some embodiments, the electrode includes a combination of a particle size gradient and a volumetric charge transfer resistance gradient. In some embodiments, the front of the electrode includes electroactive particles with sizes smaller than that of the electroactive particles in the back of the electrode. In some specific embodiments, the electrode contains graphite particles and graphite particles with smaller particle sizes, e.g., synthetic or artificial graphite such as mesocarbon microbeads, are used in the front of the electrode whereas the back of the electrode contains less porosity and electroactive material at the back of the electrode is optimized for high energy, e.g., larger particle size and/or natural graphite or highly graphitized graphite. In some embodiments, the lower-porosity region, i.e., the back of the electrode, has a conductivity substantially higher than that of the electrolyte.

In some embodiments, the electrode including one or more of the gradients described herein is coated onto a textured current collector. Textured current collector, as used herein, can include metal foam, expanded metal mesh, or a nonporous metal with a textured surface, e.g., with a roughness of 5 μm, 10 μm, 20 μm, or 50 μm. The textured surface can serve to improve adhesion and to improve the electrode electronic conductivity, particularly with thick electrodes.

Methods of fabricating an electrode with a composition gradient are described herein. The methods as described herein can be used for fabricating an electrode with two or more composition gradients. In some embodiments, methods of fabricating an electrode with graded porosity and/or compositions are described herein.

In one aspect, multiple coatings and calendering passes are used. Electrode current collector can be first coated with a first layer of electroactive material which is then subjected to a first calendering process to generate a first coating layer. A second layer of electroactive material can be then coated which is then subjected to a second calendering process to generate a second coating layer. The layers of the materials and the calendering process are selected so that the first coating layer has lower porosity than the second coating layer. In some embodiments, the first and the second layers of electroactive materials include particles with same composition and particle sizes and the first and second calendar processes are so selected to generate more porosity in the second coating layer. In some embodiments, the second layer of electroactive material is subjected to less calendering forces than the first layer of electroactive material is, thereby resulting in higher porosity in the second coating layer. In other embodiments, the first and the second layers of electroactive materials include particles with same composition but different particle sizes and compressibilities and the first and second calendar processes are so selected to generate more porosity in the second coating layer. It is known in the art that different size particles have different compressibilities. Coatings containing larger particles, for instance, generally are more compressible that coatings containing smaller particles. In some specific embodiments, the first layer of electroactive materials includes electroactive particles more compressible than those in the second layer of the electroactive materials. Thus, when the first and second coating layers include particles with the same sizes, the first calendering process is selected to generate less porosity in the first coating layer, e.g., more calendering force being used in the first calendering process. In other specific embodiments, the first layer of electroactive materials includes electroactive particles more compressible than those in the second layer of the electroactive materials. Thus, the first calendering process is selected to generate less porosity in the first coating layer, e.g., equal, more, or even less calendering force can be used in the first calendering process to generate less porosity in the first coating layer.

In some embodiments, more than two layers can be coated in a similar manner so that each subsequently coating layer has a higher porosity than its preceding coating layers, thus generating a graded porosity in the electrode with the porosity highest at the front side of the electrode.

In yet another aspect, multiple layers of different electroactive material are coated by multiple coating passes and a single calendering process is used. In this aspect, different coating layers include particles with different compressibilities and the coating layer containing particles with the most compressibility is coated first, followed by coating layer containing particles with less compressibility. A single calendering process is then applied so that a graded porosity in the electrode is generated with the porosity highest at the front of the electrode and lowest at the back of the electrode. In some embodiments, a coating layer with larger and/or more compressible particles is coated first and a coating layer with smaller and/or less compressible particles is then coated. Additional coating layer can be applied so long as the subsequent coating layers are less compressible than the particles in the preceding coating layers. A single calendering process is then applied to generate an electrode with a graded porosity wherein the porosity is highest at the front of the electrode.

In some embodiments, the graded electrode structure including one or more gradients is achieved in a single coating step followed by a single calendering process. In some embodiments, a split slot die or cascade coater can be used to deposit multiple different formulations of electroactive compositions. In some embodiments, multiple different formulations include electroactive particles with different sizes. In some embodiments, multiple different formulations include electroactive particles with different morphologies and different electrochemical and transport properties. In some embodiments, multiple different formulations include electroactive particles with two or more different compositions. In some embodiments, the split slot die or cascade coater can be used to deposit up to 20 different formulations of electroactive compositions. In some embodiments, spherical particles are used at the back of the electrode which results in less porosity and unequiaxed particles are used at the front of the electrode which results in more porosity. In some embodiments, materials that are more robust against high local reaction rates are used at the front of the electrode while materials that are less robust but have higher specific capacity are used at the back of the electrode. In these specific embodiments, the electrodes can have uniform porosity or graded porosity.

In some embodiments, the particles at the front and the back of the electrode can have different particle sizes as well as morphologies to result in a graded porosity electrode. For instance, spherical particles are known to give rise to electrode microstructures with lower ion flux path lengths, thus further improving the ion transport at the front of the electrode. However, spherical particles are also known to result in higher packing density, i.e., less porosity, than unequiaxed particles. Thus, in some embodiments, spherical particles with larger sizes can be used at the front of the electrode; and unequiaxed particles with smaller particle sizes can be used at the back of the electrode. The morphology and the particles sizes can be engineered so that the front of the electrode will have more porosity than the back of the electrode. Therefore, through careful selection of the particle size and morphology, electrodes with optimized cell properties can be fabricated. In some embodiments, the front of the electrode will have more porosity and particles with higher specific surface area compared with the back of the electrode.

In some embodiments, the porosity can average from about 10% to about 70%. It is believed that if the porosity is too high, e.g., above about 80%, then the framework may be structurally unstable; if the porosity is too low, e.g., below about 10%, then there is only an incremental increase in power or energy density. Accordingly, in some embodiments, the average porosity is from about 15% to about 50%. In some embodiment, the average porosity is from about 20% to about 35%. In some embodiment, the average porosity is about 25%. In some embodiments, the porosity gradient in an electrode is such that from the current collector toward the separator, the porosity increases from about 15% at the back side of the electrode to about 50% at the front side of the electrode. In some embodiments, the porosity gradient in an electrode is such that from the current collector toward the separator, the porosity increases from about 20% at the back side of the electrode to about 35% at the front side of the electrode.

In yet another aspect, a single coating pass is used in fabricating the electrode. In some embodiments, a coating slurry known to flocculate and form agglomerates when exposed to humid air is used in the coating process. Generally, the flocculated agglomerates are less compressible. In some embodiments, a slurry is coated onto a current collector, e.g., a foil, and the slurry is exposed to an ambient environment, e.g., humid air which promotes flocculation at the surface of the slurry. As the surface of the slurry then flocculates, surface layer of the slurry becomes less compressible. Thus, when subjected to a compressing calendering force, the surface of slurry will generate more porosity than the interior of the slurry, which contains less flocculated and more compressible composition. Therefore, a single calendering process can be applied to generate a graded porosity electrode with higher porosity at the front of the electrode.

In one or more embodiments, the graded porosity electrode as described herein maintains overall average porosity and energy density while exhibiting better cell cycle-life, power, and/or rate capability. In other embodiments, the batteries with graded porosity electrode as described herein have lower than average porosity and exhibit better cell cycle-life, power, and/or rate capability. In one or more embodiments, the cost of fabricating the electrode is reduced by using cheaper electroactive particles at the back of the electrode. In one or more embodiments, the electrode uses larger particles at the back of the electrode which results in higher energy capacity and less irreversible capacity loss. Meanwhile, smaller and less compressible particles, which are more robust towards cycling stress, are used at the front of the electrode which may result in higher porosity, better ion transport and cell rate, and improved cycle-life properties. In one or more embodiments, the graded composition electrode as described herein allows for a lower total particle surface area, thereby improving safety without sacrificing power, rate capability, or cycle life.

In yet another aspect, a method of fabricating an electrode with graded particle specific surface area is described. In some embodiments, a first type electroactive particles with lower specific surface area can be applied onto a current collector and then calendered to provide a first layer. A second type electroactive particles with specific surface area higher than that of the first type electroactive particles can then applied onto the first layer. Thus, the resulting electrode has a specific surface area gradient which decreases from the front of the electrode to the back of the electrode. Optionally, additional layers of electroactive particles with higher specific surface area can be applied. Other methods of fabricating multi-layer electrode known in the art are contemplated. In some embodiments, an electrode with graded particle specific surface area can be fabricated using multiple coating pass method as disclosed herein. In some embodiments, an electrode with graded particle specific surface area can be fabricated using a method including single calendaring step as disclosed herein. In some embodiments, an electrode with graded particle specific surface area can be fabricated using method including multi-layered coating in a single coating step (e.g. split slot die or cascade coater) with single calendaring step as disclosed herein. In some specific embodiments, particles with low specific surface area are more compressible and are used in the back side of the electrode, while particles with high specific surface area are less compressible and are used in the front of the electrode.

The electrode may utilize electrochemistry involving various alkali metals, alkaline metals, and alkaline-earth metals known in the art. Non-limiting examples of metals which can be used in the electrode include Pb, Ni, K, Na, or Li.

In some embodiments, the electrode is the positive electrode and the active material is positive active material for a lithium ion secondary battery, such as a lithium-transition metal-phosphate compound; LiCoO₂; LiNiO₂, LiMO2 where M may include a mixture of Co, Mn, and Ni or other metal; LiMn₂O₄ with or without substituents on the Li or Mn sites; or other positive-electrode material known in the art. In some embodiments, the active material is a mixture of positive-electrode materials. The lithium-transition metal-phosphate compound may be optionally doped with a metal, metalloid, or halogen. The positive electroactive material can be an olivine structure compound LiMPO₄, where M is one or more of V, Cr, Mn, Fe, Co, and Ni, in which the compound is optionally doped at the Li, M or O-sites. Deficiencies at the Li-site are compensated by the addition of a metal or metalloid, and deficiencies at the O-site are compensated by the addition of a halogen.

In some embodiments, the positive electrode containing the positive electroactive material has a specific surface area measured using the nitrogen adsorption Brunauer-Emmett-Teller (BET) method that is greater than 10 m²/g or greater than 20 m²/g. In some embodiments, the positive electrode active material includes a powder or particulates with a specific surface area of greater than 10 m²/g, or greater than 15 m²/g, or greater than 20 m²/g, or even greater than 30 m²/g. A positive electrode can have a thickness of less than 300 μm, e.g., between about 50 μm to 125 μm, or between about 80 μm to 100 μm on each side of the current collector, and a pore volume fraction between about 15 and 70 vol. %. In some embodiments, the active material is loaded at about 10-60 mg/cm² per side and typically about 10-30 mg/cm².

In some embodiments, the electrode is a negative electrode and the active material is a carbonaceous material or other lithium intercalation compound. The carbonaceous material may be non-graphitic or graphitic. A graphitized natural or synthetic carbon can serve as the negative active material. In some embodiments, graphitic materials, such as natural graphite, spheroidal natural graphite, mesocarbon microbeads and carbon fibers including mesophase carbon fibers, are used. In some other embodiments, lithium titanate (Li₅Ti₄O₁₂), alloys such as lithiated tin or lithiated silicon, alloy intermetallics, alloy or intermetallic composites with carbonaceous materials, or other potential negative electrode materials can be used. The carbonaceous material has volume-averaged particle size (measured by a laser scattering method) that is smaller than about 50 μm, or smaller than about 20 μm, or smaller than about 10 μm, or even less than or equal to about 5 μm. In some embodiments, the electroactive materials in the front of the electrode can be different from that used in the back of the electrode. In some specific embodiments, a Si-alloy is used as the negative electrode material at the back and a carbonaceous negative electrode material is used at the front. In some embodiments, the additives used in the front of the electrode can be different from that used in the back of the electrode. In some specific embodiments, a conductive carbon fiber additive is used in the front of the electrode where it is more porous, or more binder at the front where there are higher currents and more mechanical stresses.

In some embodiments, the negative active material consists of powder or particulates with a specific surface area measured using the nitrogen adsorption Brunauer-Emmett-Teller (BET) method to be less than about 6 m²/g, or 4 m²/g, or about 2 m²/g. The negative electrode can have a thickness of less than 200 μm, e.g., between about 20 μm to 150 μm, or between about 40 μm to 55 μm on each side of the current collector, and a pore volume fraction between about 15 and 40 vol. %. The active material is typically loaded at about 3-30 mg/cm² per side, or about 4-8 mg/cm².

Numerous organic solvents have been proposed as the components of Li ion battery electrolytes, notably a family of cyclic carbonate esters such as ethylene carbonate, propylene carbonate, butylene carbonate, and their chlorinated or fluorinated derivatives, and a family of acyclic dialkyl carbonate esters, such as dimethyl carbonate, diethyl carbonate, ethylmethyl carbonate, dipropyl carbonate, methyl propyl carbonate, ethyl propyl carbonate, dibutyl carbonate, butylmethyl carbonate, butylethyl carbonate and butylpropyl carbonate. Other solvents proposed as components of Li ion battery electrolyte solutions include γ-BL, dimethoxyethane, tetrahydrofuran, 2-methyl tetrahydrofuran, 1,3-dioxolane, 4-methyl-1,3-dioxolane, diethyl ether, sulfolane, methylsulfolane, acetonitrile, propiononitrile, ethyl acetate, methyl propionate, ethyl propionate and the like. These nonaqueous solvents are typically used as multicomponent mixtures.

As the lithium salt, at least one compound from among LiClO₄, LiPF₆, LiBF₄, LiSO₃CF₃, LiN(SO₂CF₃)₂, LiN(SO₂CF₂CF₃)₂ and the like are used. The lithium salt is at a concentration from 0.5 to 1.5 M, or about 1.0 M.

The electroactive material, conductive additive and binder are combined to provide a porous composite electrode layer that permits rapid lithium diffusion throughout the layer. The conductive additive such as carbon or a metallic phase is included in order to improve its electrochemical stability, reversible storage capacity, or rate capability. Exemplary conductive additives include carbon black, acetylene black, vapor grown carbon fiber (“VGCF”) and fullerenic carbon nanotubes. Conductive additives are present in a range of about 1%-5% by weight of the total solid composition of the electrode. The binder used in the electrode may be any suitable binder used as binders for non-aqueous electrolyte cells. Exemplary materials include a polyvinylidene fluoride (PVDF)-based polymers, such as poly(vinylidene fluoride) (PVDF) and its co- and terpolymers with hexafluoroethylene, tetrafluoroethylene, chlorotrifluoroethylene, poly(vinyl fluoride), polytetraethylene (PTFE), ethylene-tetrafluoroethylene copolymers (ETFE), polybutadiene, cyanoethyl cellulose, carboxymethyl cellulose and its blends with styrene-butadiene rubber, polyacrylonitrile, ethylene propylene diene terpolymers (EPDM), styrene-butadiene rubbers (SBR), polyimides, ethylene-vinyl acetate copolymers.

The positive and negative electrode layers can be manufactured by applying a semi-liquid paste containing the appropriate electroactive compound and conductive additive dispersed in a solution of a polymer binder in an appropriate casting solvent to both sides of a current collector foil or grid and drying the applied electrode composition. A metallic substrate such as aluminum or copper foil or expanded metal grid is used as the current collector. The dried layers are calendared to provide layers of desired thickness and density.

A gel electrolyte may also be employed. The electrolyte may contain a high molecular weight solid electrolyte, combined with a liquid to produce a gel, provided that the material exhibit lithium conductivity. Exemplary high molecular weight compounds include poly(ethylene oxide), poly(methacrylate) ester based compounds, or an acrylate-based polymer, and the like.

The electrode described in any of the embodiments herein can be used in a battery. In some embodiments, the electrode described herein is be used in a lithium ion battery.

The electrode containing one or more composition gradients can be a positive electrode or a negative electrode. A battery cell as disclosed herein may include a positive electrode with one or more gradients and/or a negative electrode with one or more gradients

### Example 1

An electrode slurry containing active material particles and conductive additive was dispersed in a solution of polyvinylidene difluoride binder dissolved in n-methylpyrrolidone. This slurry was deposited onto a current collector substrate (e.g. via a slot die coater) and passed immediately into a high humidity chamber prior to drying (the first stage of drying can also be the high humidity chamber.) The high humidity resulted in moisture uptake by the solvent at the surface of the slurry, which destabilized the slurry at the surface by making the solvent (now a solution of water and n-methylpyrrolidinone) a non-solvent for the binder, which dropped out of solution and “coagulates” the outer surface of the slurry via phase separation. This phase separation resulted in a very low density flocculated structure at the surface, which upon complete drying had a lower green density than the underlaying layer of electrode material which was not affected by the moisture uptake. The surface layer, having a lower green density and flocculated structure, was less compressible than the underlying layer, resulting in higher porosity at the surface than at the base of the electrode after calendering (roll densification).

### Example 2

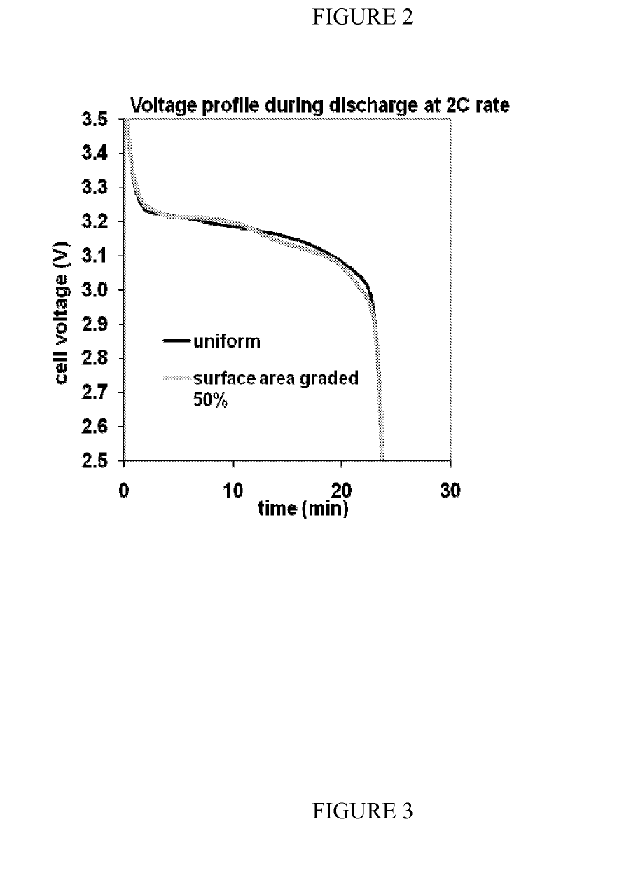

A computer simulation was used to explore the effect of specific surface area gradient on battery performance. The model was based on that described in T. Fuller, M. Doyle, and J. Newman, J. Electrochem. Soc. 1994 p. 1 and K. E. Thomas, R. M. Darling, and J. Newman (2002), Modeling of Lithium Batteries, in Advances in Lithium Ion Batteries, ed. B. Scrosati and W. van Schalkwijk, New York: Kluwer Academic Publishers. In the model, the specific surface area could be input as a function of position across the thickness of the electrode. Simulation results are shown in FIG. 2 for lithium ion cells utilizing a graphite negative electrode and a lithium iron phosphate positive electrode. As shown in FIG. 2, a lithium ion cell with graded specific surface area across the negative electrode is compared with a lithium ion cell with uniform specific surface area throughout the electrode. The average specific surface area of the particles in the uniform negative electrode is the same as the average specific surface area of the particles in the negative electrode with graded specific surface area. In the lithium ion cell with graded specific surface area, the front half of the electrode has a particle specific surface area 50% higher than the particle specific surface area in the lithium ion cell with uniform specific surface area, and the back half of the electrode has particle specific surface area 50% lower than the particle specific surface area of the lithium ion cell with uniform specific surface area. FIG. 2 shows the voltage profile during a discharge at the 2 C rate. Higher voltage can result in higher energy output delivered from the cell. As shown in FIG. 2, the lithium ion cell with graded specific surface area provides a higher cell voltage (lower resistance) during the first half of the discharge, and provides a lower voltage (higher resistance) at latter half of the discharge.

### Example 3

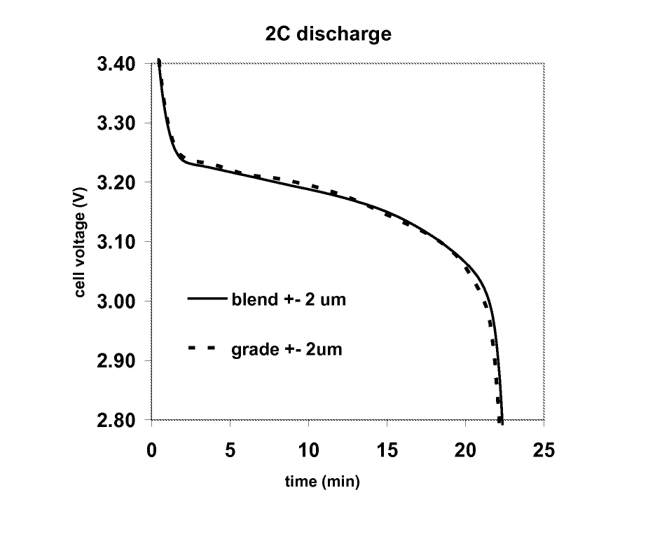

A computer simulation was used to explore the effect of specific surface area gradient on battery performance based on the model described above in Example 2. The model was used to study the effect of graded particle size. The model was run with two particle sizes in the negative electrode, one particle with particle radius 2 μm smaller than average, and the other particle with radius 2 μm larger than average. The volume fraction of each particle size was 50%. Two cases were run. The first case was a blend, i.e., both particle sizes exist at every position across the thickness of the electrode, and the model includes calculation of the reaction rate and solid-phase diffusion in each particle type. The second case was a graded electrode, in which the larger particles were placed at the back of the electrode and the smaller particles at the front. FIG. 3 shows that the cell voltage during a 2 C-rate discharge is higher, i.e., the cell impedance is lower, with the graded electrode than the blended electrode at the beginning of discharge. At the end of discharge, the impedance is higher in the graded electrode because the material at the front of the electrode has been consumed and the reaction has shifted to the back of the electrode.

### Example 4

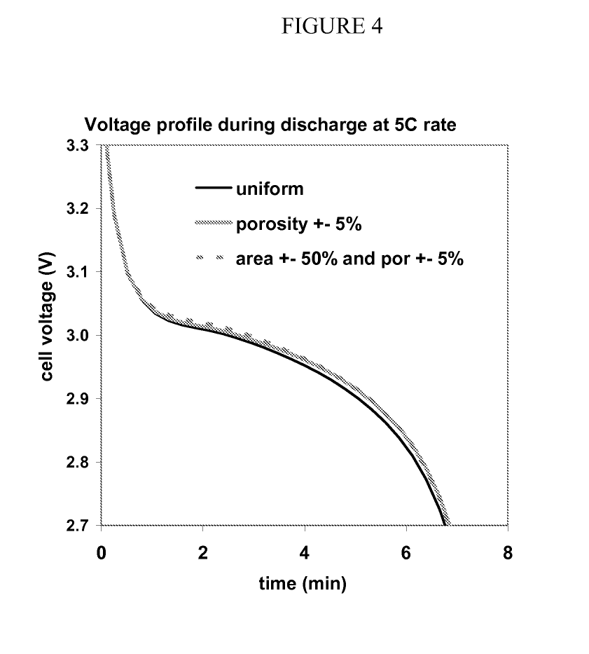

A computer simulation was used to explore the effect of a porosity gradient and a combined porosity and specific surface area gradients on positive electrode performance. The model was described above in Example 2. The model was used to look at the combined effects of graded porosity and specific surface area gradient (note that the specific surface area gradient resulted in a volumetric charge-transfer resistance gradient) during a 5 C-rate discharge starting from the fully charged state. In this case, the grading was done on the positive electrode. A positive electrode including lithium iron phosphate was simulated. Three simulations were run. The first simulation was conducted on a positive electrode with a uniform composition. The second simulation was conducted on a positive electrode with a porosity gradient, where the porosity of the front half of the electrode is 5 vol % higher than the average porosity of the electrode and the porosity of the back of the half electrode is 5 vol % lower than the average porosity of the electrode. In the third simulation, the charge-transfer resistance (or specific surface area of the particles) was graded in addition to the porosity. The charge-transfer resistance of the front half of the electrode was 50% lower than the average charge-transfer resistance of the electrode and the charge-transfer resistance of the back half of the electrode was 50% higher than the average charge-transfer resistance of the electrode. The results are shown in FIG. 4. The cell voltage is improved (i.e., impedance is lowered) at all times by grading the porosity. The cell voltage is further improved during the first 3 minutes of discharge by grading the charge-transfer resistance in addition to the porosity gradient.

The foregoing illustrates one specific embodiment of this invention. Other modifications and variations of the invention will be readily apparent to those of skill in the art in view of the teaching presented herein. The foregoing is intended as an illustration, but not a limitation, upon the practice of the invention. It is the following claims, including all equivalents, which define the scope of the invention.

1. An electrode assembly comprising:
a current collector; and
an electrode having a front face furthest from the current collector and a back face closest to the current collector disposed on the current collector, wherein the electrode has a primary gradient of one of a chemical, physical and performance properties of the electroactive particle composition between the front and back faces, with the proviso that the primary gradient is not a bulk porosity gradient.

2. The electrode assembly of claim 1, wherein said primary gradient is selected from the group consisting of particle size gradient, particle size distribution gradient, particle morphology gradient, particle internal porosity gradient, particle volumetric charge-transfer resistance gradient, particle specific surface area gradient, particle crystalline structure gradient, particle crystallite size gradient, particle chemical composition gradient, and particle robustness to cycling gradient.

3. The electrode assembly of claim 1, wherein the primary gradient comprises a continuous or stepwise change of electrode composition.

4. (canceled)

5. The electrode assembly of claim 3, wherein the electrode comprises a plurality of layers with different electrode compositions.

6. An electrode with a compositional gradient on a current collector, comprising:
a first type electroactive particles at a front side of the electrode further from a current collector; and
a second type electroactive particles at a back side of the electrode closer to the current collector;
wherein
the compositions of the first type particles and the second type particles form a particle compositional gradient changing from the font side of the electrode to the back side of the electrode; and
the compositional gradient comprises at least one gradient of particle size, particle porosity, particle morphology, particle power characteristics, particle specific surface area, particle crystalline structure, particle crystallite size, amount of conductive additive in a particle layer, or amount of binder in a particle layer.

7. The electrode assembly of claim 1 or 6, wherein the electrode further comprises one or more secondary gradients.

8. The electrode assembly of claim 7, wherein the secondary gradient is one or more gradients selected from the group consisting of particle size gradient, particle size distribution gradient, particle morphology gradient, particle internal porosity, bulk porosity, particle volumetric charge-transfer resistance gradient, particle specific surface area gradient, particle crystalline structure gradient, particle crystallite size gradient, particle chemical composition gradient, particle robustness to cycling gradient, binder gradient, conductive additive gradient, and combinations thereof.

9. The electrode assembly of claim 1 or 6, wherein the electrode comprises a particle volumetric charge transfer resistance gradient wherein the volumetric charge-transfer resistance of the electrode particles increases from the front face to the back face of the electrode.

10. The electrode assembly of claim 9, wherein the electrode comprises synthetic carbon, hard carbon, or a combination thereof at a first location, and natural graphite, high-capacity synthetic carbon, or a combination thereof at a second location, wherein the second location is closer to the current collector than the first location.

11. (canceled)

12. The electrode assembly of claim 1 or 6, wherein the electrode comprises a carbon material with a d(002) lattice spacing of more than 3.36 Å at a first location and a carbon material with a d(002) lattice spacing of less than 3.36 Å at a second location, wherein the second location is closer to the current collector than the first location.

13. The electrode assembly of claim 1 or 6, wherein the electrode comprises a particle size gradient, a particle morphology gradient, a particle specific surface area gradient, a particle internal porosity gradient.

14. (canceled)

15. (canceled)

16. (canceled)

17. (canceled)

18. (canceled)

19. (canceled)

20. The electrode assembly of claim 7, wherein the electrode comprises a particle size gradient and a porosity gradient.

21. (canceled)

22. The electrode assembly of claim 7, wherein the electrode comprises a particle volumetric charge-transfer resistance gradient and a porosity gradient.

23. (canceled)

24. The electrode assembly of claim 7, wherein the electrode comprises a particle specific surface area gradient and a porosity gradient.

25. (canceled)

26. The electrode assembly of claim 7, wherein the electrode comprises a particle volumetric charge-transfer resistance gradient and a particle specific surface area gradient.

27. (canceled)

28. The electrode assembly of claim 7, wherein the electrode comprises a particle volumetric charge-transfer resistance gradient, a particle specific surface area gradient, and a porosity gradient.

29. (canceled)

30. The electrode assembly of claim 7, wherein the electrode comprises a particle size gradient, a particle specific surface area gradient, and a porosity gradient.

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. An electrode with graded porosity on a current collector, comprising:
a first type electroactive particles at a front side of the electrode further from a current collector; and
a second type electroactive particles at a back side of the electrode closer to the current collector;
wherein
the first type electroactive particles have smaller particle sizes than the second type electroactive particles; and
the electrode has a graded porosity which is higher at positions at the front side of the electrode and lower at positions at the back side of the electrode.

47. The electrode of claim 46, wherein the graded porosity comprises a continuous porosity gradient comprising a continuous or stepwise change of particle porosity from the front side to the back side.

48. (canceled)

49. The electrode of claim 47, wherein the electrode comprises a plurality of layers of electroactive particles with different porosities, wherein the layer further away from the current collector has porosity higher than the layer closer to the current collector.
